(19) United States
(12) Patent Application Publication
(10) Pub. No.: US 2006/0151401 A1
(43) Pub. Date: Jul. 13, 2006

(54) Method and reactor for decalcifying and simultaneously removing harmful substances

(76) Inventor: Massoud Karimnia, Hamburg (DE)

Correspondence Address: SAND & SEBOLT, AEGIS TOWER, SUITE 1100, 4940 MUNSON STREET, NW, CANTON, OH, 44718-3615, US

(21) Appl. No.: 10/530,163

(22) PCT Filed: Oct. 7, 2003
(86) PCT No.: PCT/EP03/11076

§ 371 Date: Apr. 4, 2005

(30) Foreign Application Priority Data
Oct. 12, 2002 (DE) 102476861

(51) Int. Cl. C02F 1/72

(52) U.S. Cl. 210/758

(57) ABSTRACT

The invention relates to a process and to a reactor for deliming water and simultaneously removing pollutants, as well as the disinfection and destruction of permanent forms of parasites. The prior art operates with relatively high apparatus and energy costs and the results obtained are frequently inadequate. According to the invention these problems are obviated in that the water is directly or indirectly heated in the treatment chamber, that one or more horizontally directed plates with perforated border for deflecting the water flow and for receiving residues are fixed in the lower area of the reactor spaced from the bottom and side wall thereof and that a gassing device is provided outside the reactor having a pipe with gas distributor leading centrally into the reactor and which terminates below the plate or plates and where in a discontinuously operated reactor the out let is located between the reactor bottom and the plate or plates, whereas in a continuously operated reactor the outlet is positioned above the plate or plates.

The invention relates to a process for the deliming or decalcification of water and the simultaneous removal of pollutants and contaminants, together with the disinfection and destruction of bacteria and permanent forms of parasites in a reactor with an inlet and out let according to the preamble of claim 1.

Calcium hydroxide precipitation, seeding devices for calcium carbonate formation and ion exchangers are widely used for the deliming of water. These processes involve a chemical treatment. However, there are also processes having a physical basis. The latter include deliming by modifying the crystal structure in the magnetic field, e.g. DE 43 36 388, cavitation, reverse osmosis and membrane filtration. There are also thermal treatment processes, e.g. patent application DE 197 27 357 A1, which aim at preventing the deposition of lime in domestic installations. By supplying heat at between 50 and 90° C. in a continuously operating installation lime formation is brought about, so that no further lime formation occurs in the domestic installations.

All the aforementioned processes generally bring about a positive influencing of the deposition of lime or the prevention of lime formation in installations. However, it is disadvantageous that these processes do not simultaneously aim at effective lime reduction and pollutant elimination in water, together with the conditioning thereof and can consequently not be used or can only be considered to a limited extent for e.g. the treatment of drinking water, ground water and surface water. In some processes the procedure adopted is complicated and they cannot be used in a practical, profitable manner for larger water quantities.

A disadvantage of the thermal process according to DE 197 27 357 A1 is that it is ineffective and energy-intensive with respect to reaction management. In addition, long residence times are involved and consequently pollutants are either not or only inadequately eliminated. The known apparatus and process are also unsuitable for the treatment of drinking water in discontinuously operating plants and on a small scale (e.g. in the home).

In the case of ion exchangers, calcium and magnesium ions are exchanged with other ions, which are cast into doubt in drinking water treatment as a result of their health actions, because they lower the pH-value by delivering protons to the water. In addition, there are bacteriological objections and after exhaustion must be regenerated with chemicals and consequently have a prejudicial influence on the environment. It is a disadvantage of small installations used in the home and which delime water with the aid of ion exchangers that apart from the reduction of the pH-value to below the limit value laid down in drinking water regulations, capacity fluctuations and lack of reliability of their effectiveness during use, that it is not possible to establish when exhaustion has taken place. As is known in domestic appliances ion exchangers are housed in replaceable plastic cartridges. It has been reported that in drinking water treatment equipment made from plastic, as a result of the latter plasticizers are delivered to the water.

The problem of the present invention is to improve the aforementioned process in such a way that the above-described problems are avoided and without significant apparatus expenditure and maintenance water can be delimed and simultaneously pollutants and contaminants can be eliminated from the water and the disinfection and destruction of permanent forms of parasites are implemented. A further aim is to so adjust the lime-carbonic acid equilibrium in a clearly defined and pre-determinable manner as to prevent fouling of installations. Lime deposits in both continuously and discontinuously operating reactors must be detached from the heat transfer surfaces and must not lead to a permanent fouling.

The problem and aim are solved according to the invention by the process characterized in claim 1 and by the reactor according to claim 2.

On heating water the flow is to a greater or lesser extent laminar and occurs relatively speaking in the inner area of the water. As a result of the plate or plates used in the reactor with air gassing, according to the invention the laminar flow is transformed into a turbulent, convective flow. In addition, said turbulence is brought as close as possible to the interface (reactor wall) in order in this way to increase the material exchange there and speed up the heterogeneous crystal nucleation, because in the case of heterogeneous nucleation due to the surface energy of the different type of phase the critical nucleation energy and consequently also the nucleus radius are reduced. Therefore heterogeneous and secondary nucleation take place with reduced supersaturation. The plate or plates also offer further surfaces for preferred heterogeneous crystal nucleation.

In the case of the crystallization of hardening elements in water, precipitation crystallization is involved. As is known, crystallization in the case of precipitation crystallization only starts with a higher supersaturation and therefore greater importance is attached to heterogeneous than to homogeneous nucleation. Nucleation and crystal growth are also encouraged by suitable material and rough material exchange surface between the reactor wall and water. Heterogeneous nucleation is also assisted by gas bubbles as foreign particles.

Both macromixing and micromixing of the reactants have a positive effect on nucleation in the case of precipitation crystallization. Gassing and the production of an intense mixing zone below the plate or plates with simultaneous carbon dioxide desorption ensure that crystallization takes place with a much lower supersaturation than would otherwise be the case. Crystallization with lower supersaturation also means that more lime and carbon dioxide are removed from the water. A further consequence of this is that the pH-value of the water with the aid of this process rises to a higher level than when deliming in conventional reactors, which leads to a better heavy metal hydroxide precipitation.

Calcium and magnesium carbonate, as well as calcium sulphate, as opposed to other salts, have the property of a decreased solubility with increased temperature in the water. Therefore supersaturation on warmer contact surfaces (heating surface and reactor wall) for nucleation takes place earlier than in water. Therefore the crystallization of these salts mainly takes place on these surfaces. The deflection of the water flow in the vicinity of the reactor wall reduces the laminar layer in this area and favours material and energy exchange. Therefore the surface of the hotter reactor) gains major significance in water. According to the invention exchange face (slenderness ratio of the precipitation of hardening elements lateral heating of the reactor additionally aids crystallization. This can be brought about both by electric ring-type heaters and by a double-walled reactor, whose jacket is heated with the aid of superheated steam or hot oil.

The invention also makes use of the property of gases that on the one hand with rising temperature their solubility in water decreases and on the other with the aid of a stripping gas gases are mechanically expelled from the water. In addition, a temperature rise coupled with gassing leads to a more effective gassing out of medium and readily volatile compounds, lime deposition, precipitation of certain salts and oxidation of oxidizable substances. Atmospheric oxygen is known to be an oxidant and is often used for drinking water treatment.

As a function of the water consistency, pH-value, concentrations of hardening elements and further water parameters and the desired objectives during treatment, not only is the water heated and aerated, but if necessary either its temperature is kept constant by a lower heat supply than previously in said temperature range and/or air gassing is continued for a longer time.

The process according to the invention also utilizes the possibility of an improved heat transfer, chemical reactions at elevated temperatures and pH rise, together with convective intermixing by air gassing and the boiling process if the water has to be heated to boiling.

The speed of crystal nucleation, crystal growth during precipitation crystallization and further reactions within the treatment chamber are dependent on different parameters. These are inter alia supersaturation of the precipitating salts, different types of particles in the water, desorption of the resulting gas, the material of the reactor (surface energy and wettability) and the surface structure (roughness) of the material exchange surface and finally the water flow rate at the interface permitting a more intense surface renewal at the interfaces.

With regards to the reactor material in connection with precipitation crystallization, the nucleation energy is reduced at surfaces with good wettability by water. The reason is that such a material forms a small contact angle with the water droplets. Nucleation at these surfaces or the contact angle between water and material surface are, however, to a significant extent dependent on the roughness of the reactor and plate surface. Although a smooth surface can be wetted relatively well, wettability is further improved by roughening. However, for roughening, greater importance is attached to microscopic rather than macroscopic roughness.

In known treatment processes using thermal energy, the specific characteristics of individual chemical and physical processes in water are paid little attention in that nucleation is a time and energy-dependent reaction, associated with material and energy exchange processes and complexing reactions, together with crystallization, whose effectiveness like all chemical and physical reactions is dependent on an optimization of re action management.

In the case of reactions in water in conventional reactors an effective combined deliming and pollutant elimination without adding chemicals can only be brought about at boiling temperature and with very long residence times, because turbulence caused by steam bubbles formed not only is an increased diffusion rate made possible, but due to an increased mechanical intermixing a further improved material exchange is brought about (collision theory).

As a function of the water pH-value, carbon dioxide is both physically and chemically dissolved in water in the form of carbonic acid, so that it is not easy to expel it from the water. However, this can be accelerated by mechanical circulation (e.g. gassing).

In simplified form the following reactions occur in water during lime formation:
CO₂+H₂O═HCO₃⁻+H⁺ (1)
HCO₃═CO₃²⁻+H⁺ (2)

On transforming hydrogen carbonate into carbonate, the following reaction takes place:
2HCO₃⁻═CO₃ ¹⁻+CO₂+H2O (3)

These equilibrium reactions are decisively dependent on the temperature, pH-value and carbon dioxide concentration with regards to the direction in which they move. As is known, the equilibrium can be shifted in the desired direction by removing from the reaction chamber the reactants participating in the reaction. A formation of less hydrogen carbonate and therefore a shifting of the equilibrium to the left in reaction (1) is dependent on carbon dioxide removal. This also applies for reaction (2) on forming carbonate and a shifting of the reaction to the right.

If the dissolved and forming carbon dioxide is removed from the system, the water pH-value is raised and consequently less hydrogen carbonate and less carbonate are formed. Thus, compared with conventional processes, much less lime and therefore fouling take place in the reactor.

As the solubility of gases decreases with rising temperature, there is automatically a partial stripping of CO₂ from the water by diffusion up to the equilibrium concentration at the particular temperature. However, this process is slow and therefore constitutes the speed-determining step during carbonate precipitation.

The temperature rise, CO₂ removal, residence time, crystal nucleation, crystal growth, together with the geometric and hydrodynamic conditions in the reactor consequently all play a part for an effective lime reduction and pollutant elimination. Thus, as a result of a simple temperature rise the reactions do not automatically take place in a rapid, optimum manner, but must instead be assisted by other measures.

In other words if steam formation during the boiling of the water inter alia also provides mechanical energy and leads to turbulence, said mechanical energy can e.g. be supplied to the system with the aid of gassing at lower temperatures and consequently deliming can be implemented with a lower energy usage and shorter residence time. In this case by aerating and the horizontal plate or plates used water can even have the same effects with regards to lime formation at lower temperatures (e.g. 80° C.) as occurs on boiling and the transformation of hydrogen carbonate into carbon dioxide and carbonate takes place at much lower temperatures than have hitherto been assumed. However, the difference between mechanical and thermal energy is that the former has a significantly lower energy consumption.

A part is played by the heat transfer from the heating surface to the water on heating the latter. As a result of the introduced plates with simultaneous aeration, said process is intensified by intense intermixing of the water and consequently there is a rapid heat compensation in the reactor. Due to increased turbulence and the formation of micromixing particularly below the plates, heat compensation takes place particularly rapidly here.

It is therefore comprehensible that unlike in the process described in DE 197 27 357 A1, the production of a new carbonic acid equilibrium at a specific temperature takes place much more favourably from the energy standpoint through a combination of temperature increase and air gassing and with a lower temperature. In addition, with the aid of hydrodynamic optimization of reaction management (use of plates) in the reactor, the necessary residence time for crystallization as a further speed-determining step is reduced and the treatment chamber volume becomes much smaller, so that the reactor can be made more compact.

As explained hereinbefore, a removal of CO₂ from the water leads to a reduction of the carbonic acid concentration in the water and then, as a function of the buffering capacity of the water, this leads to a pH-value rise well above one unit. As is known certain metals and heavy metals (e.g. iron, manganese, copper, nickel, cadmium, lead, arsenic and radionuclides) form difficultly soluble carbonates and in the basic range difficultly soluble hydroxides in water, all known as difficulty soluble compounds, and correspondingly their solubility products are deposited as sediments. Colloidally present turbidities in the water (e.g. humic substances) are also partly adsorbed by carbonates and complex compounds and are sedimented at the end of the process. In addition, gases, readily and medium-volatile substances other than carbon dioxide, such as chlorine, ammonia, hydrogen sulphide and further organic substances having a higher vapour pressure than water, including readily volatile organic hydrocarbons (LHKW), byproducts of the chlorination of water, etc. and which occur as contamination in water, are removed from the water. Just as in the case of carbon dioxide, the performance of these processes is brought about by simultaneous temperature increase and stripping.

As is known many organic and inorganic compounds are oxidized in the presence of oxygen as oxidant and are removed from the water as difficulty soluble salts, e.g. iron and manganese. Oxidation takes place more rapidly at higher temperatures (so-called wet oxidation). Oxidation reactions can also be permitted or accelerated by the use of e.g. ozone.

A further function of the plate or plates is that as a result of intense mixing and possible boiling of the water the lime deposits form multilayer crystals, which have a lower adhesive strength rather than vertically growing crystals. In the case of a turbulent flow, there are intensely strong, locally acting increases of the liquid speed in the vicinity of the surfaces in the form of very varied bursts. As a result of stresses which occur every so often the multilayer crystals are detached in the form of lamellas and fed into the water. This is independent of whether the reactor is heated by direct or indirect heating. This prevents calcification of the reactor and heat transmission is not reduced by calcification of the heating surface.

When treating drinking water in the reactor according to the invention, as stated hereinbefore, a higher pH-value is obtained in addition to pollutant elimination. Numerous medical experts have reported that certain illnesses are caused by acidification of foods and therefore our body as a result of the industrial production of foods and consequently recommend the consumption of alkaline foods. It should also be clear that the water has an improved taste after treatment. These two effects can be referred to as water conditioning. It is stated in DE 198 29 984 A1 that a fundamental taste improvement is brought about by mixing water with air. A heating of the water to above 70° C. is also a reliable method for disinfecting the water and destroying legionella bacteria therein.

In the simplest embodiment of the apparatus according to the invention use is made of a discontinuously operating apparatus or reactor, which is heated and ventilated from below by the use of an external energy source. In the treatment chamber of said reactor a plate is fixed to the cover of the treatment chamber and not to the reactor wall at a distance from the bottom for guiding the flow and intensifying turbulence. The plate is positioned horizontally and centrally in such a way that the aforementioned conditions are optimized. The plate has a perforated border and consequently additionally has the function of trapping and retaining on the plate the precipitating residues. On pouring out the water the residues are left behind on the plate or plates and the water on the latter can run out through the holes, so that on plate removal no further water is located thereon. Most of the fouling elements formed and which have detached from the reactor wall and heating surface in the form of lamellas drops subsequently onto the horizontal plate and the remainder onto the bottom of the treatment chamber. Following the sedimentation of the residues the water can be removed through the outlet, because the latter is positioned above the bottom, whilst residual residues with a certain amount of water are left behind in the treatment chamber. Through the removal of the cover, following the emptying of the treatment chamber the residues which are located on the plate fixed to the cover can be externally washed off. Thus, the reactor according to the invention, other than the washing off of residues, requires no further maintenance or the like. The remaining residues and the water on the bottom of the treatment chamber can remain in the latter, because the plate fulfils the function of discharging residues.

To reduce the volume of the remaining water in the treatment chamber, in the case of discontinuous operation the chamber is narrowed somewhat at the bottom.

Also in the case of small reactors, after treatment the water must only be removed from the treatment chamber through the outlet, because otherwise there would be a mixing of residues and water.

As a function of the deliming and pollutant reduction task, the thus treated water, immediately after treatment, can be removed from the treatment chamber, or said removal may only be necessary following cooling in the treatment chamber, because frequently compounds have a lower solubility at low temperatures.

In summarizing, the invention is based on the following:

The use of plates, accompanied by a simultaneous heating, contributes to an intense, partial mixing occurring below the plates.

Heating generally gives rise to a flow with increasing diffusion rate in the water and this leads to water mixing. The introduction of air not only speeds up the desorption of the carbon dioxide, but also contributes to a homogeneous macromixing and micromixing of the water. Micromixing plays a decisive part in the case of precipitation crystallization.

If for any reason aeration is not possible, plate use and optimized hydrodynamic conditions with simultaneous heating is quite adequate, because one of the decisive steps is the production of micromixing below the plates. However, it is clear that under such circumstances the process lasts somewhat longer than when there is simultaneous aeration.

As is known the process of heterogeneous crystal nucleation and crystal growth on different types of surfaces and particles takes place as homogeneous nucleation and in the case of precipitation crystallization heterogeneous nucleation is more significant than homogeneous nucleation. Greater significance is also attached to the higher temperature on the reactor walls during the crystallization of hardening elements. It follows from that:

a. the optimized slenderness ratio of the treatment chamber also plays a not to be underestimated part in deliming and

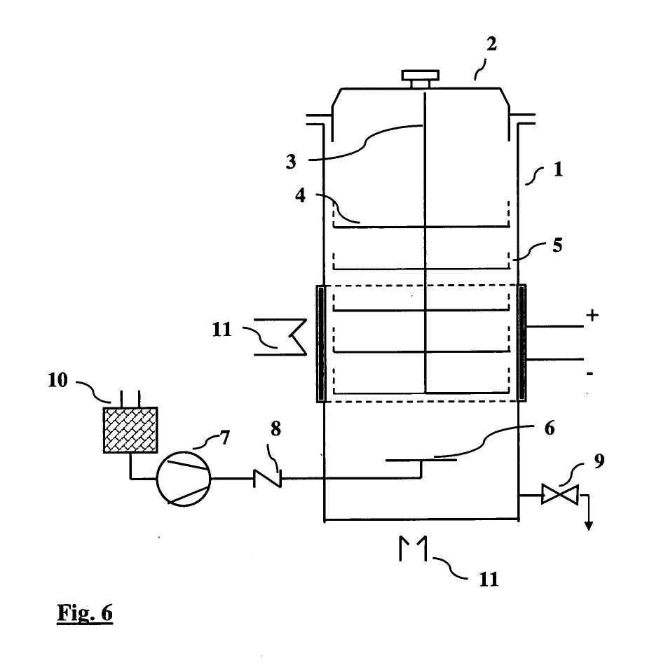

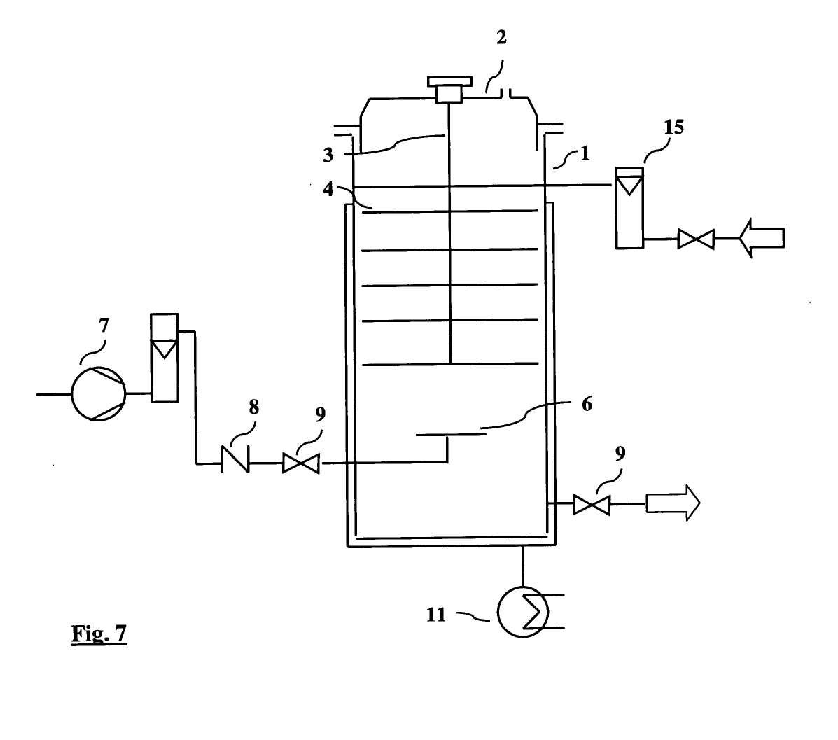

b. the process is accelerated not only by a heating of the reactor from below, but also a lateral heating. Lateral heating can be ensured both with the aid of electric ring-type heaters or in the form of a double-walled reactor, which is heated with oil or steam (FIGS. 6 and 7).

When carrying out deliming according to the process of the invention, firstly the associated, aggressive carbon dioxide is stripped from the water and the resulting supersaturation leads to nucleation. In the next step the hydrogen carbonate is transformed into difficultly soluble calcium and magnesium carbonate, as well as carbon dioxide. At this stage the advance of the reaction is mainly dependent on the speed with which the carbon dioxide is removed from the water.

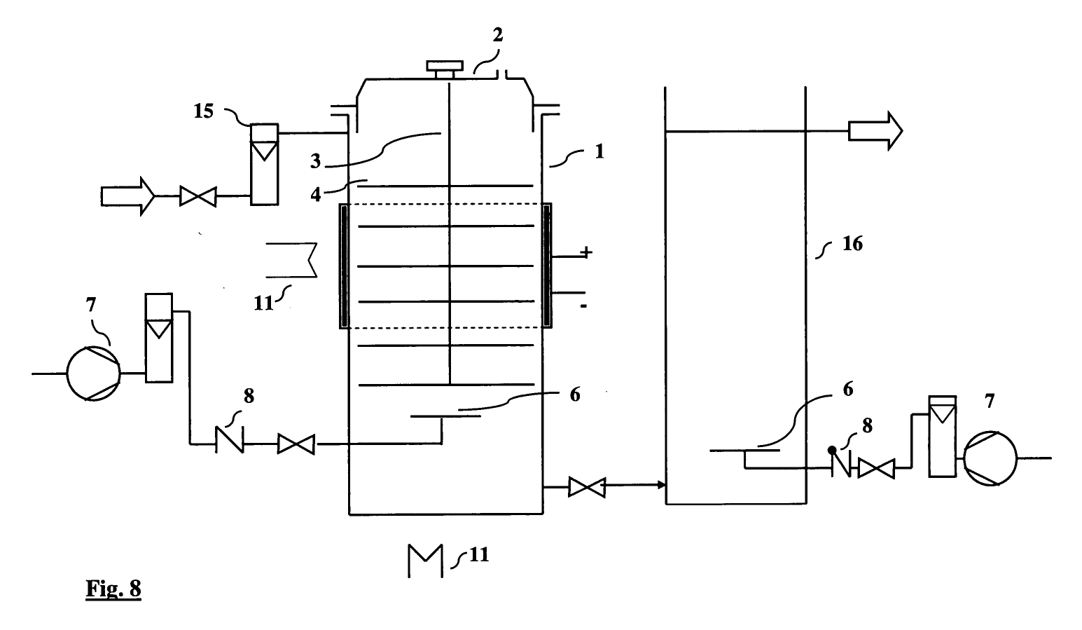

Thus, when performing the process continuously the final step can be performed in a further, simple bubble column with aeration and without additional heating, where as a result of there being no plates there can be a higher mass transfer coefficient for stripping than in the first reactor (FIG. 8). For this purpose it is also possible to work with a higher air flow rate than in the first reactor. As a result of this measure the residence time of the water in the first reactor is reduced, as is the energy consumption.

With regards to the reactor material in connection with precipitation crystallization, nucleation energy on surfaces with good wettability by water is reduced. The reason for this is that in this way a material forms a small contact angle with water. Nucleation at these surfaces or the contact angle between water and the material surface are also dependent to a significant extent on the roughness of the reactor material and the plate or plates. Although a smooth surface can be wetted relatively well, wettability is further improved by roughening. However, what is decisive in connection with roughening is its microscopic nature, because this further reduces the contact angle.

Further advantages and features can be gathered from the subclaims, which can also have inventive significance together with the main claim. Preferred embodiments of the invention are described in greater detail hereinafter relative to the attached drawings. The invention is not limited to the examples shown.

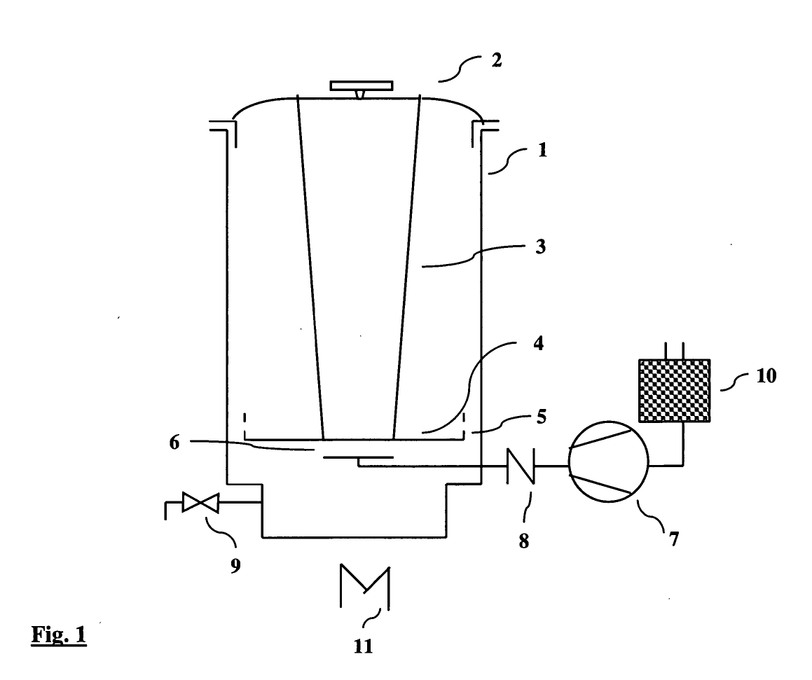

FIG. 1 is a diagrammatic cross-sectional view through a reactor according to the invention in its simplest form and which has a gassing device.

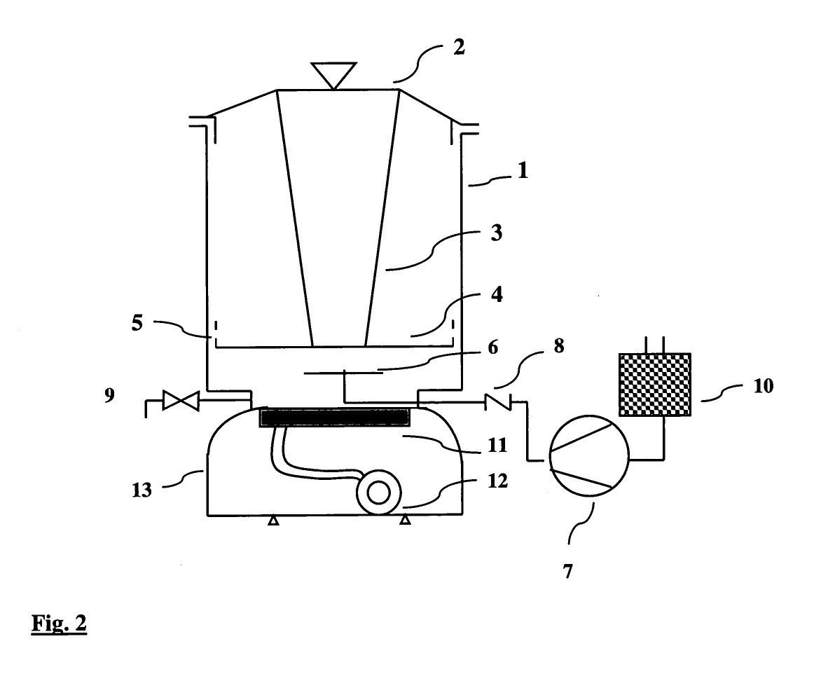

FIG. 2 shows diagrammatic cross-sectional views of two further reactors.

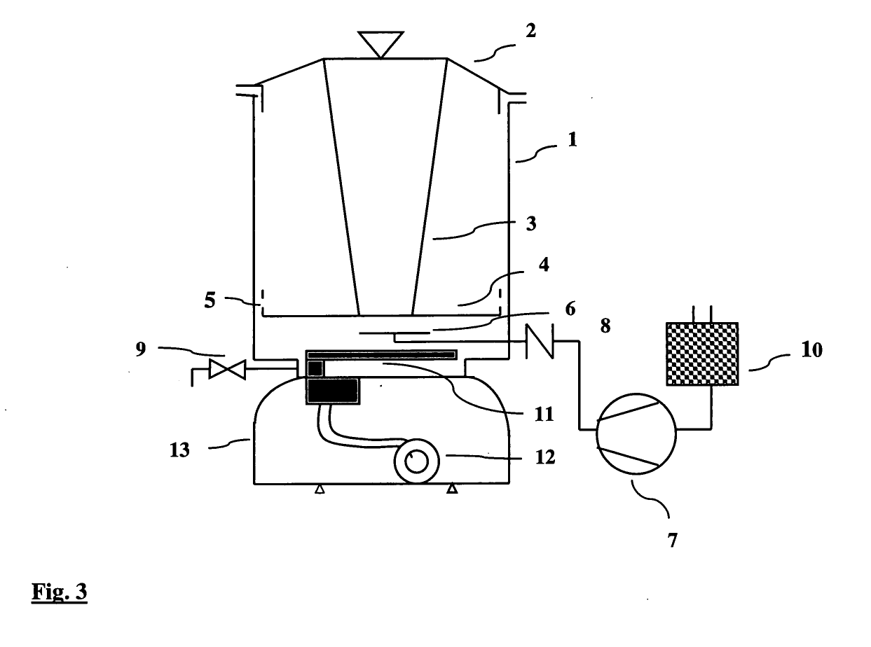

FIG. 3 shows reactors according to the invention with their own direct and indirect, electric heating devices and external gassing.

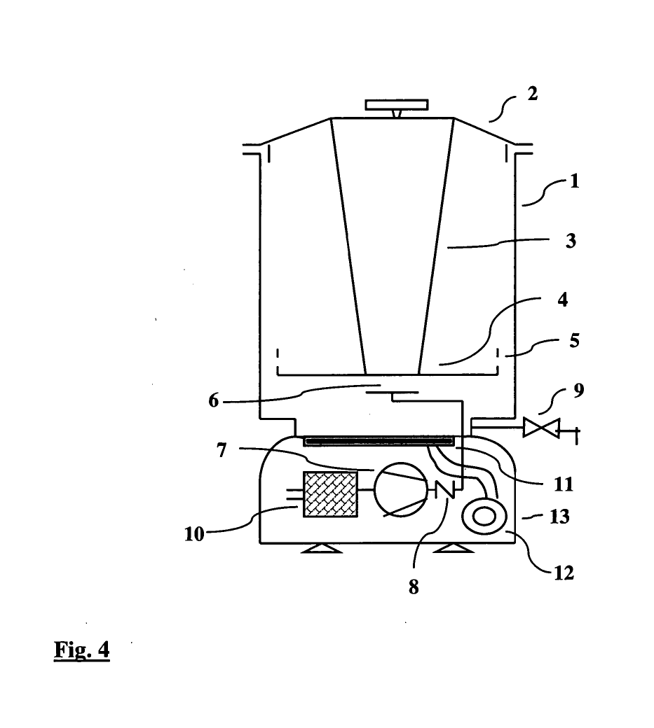

FIG. 4 is a diagrammatic representation of a further embodiment of the inventive reactor with internal heating device and ventilation.

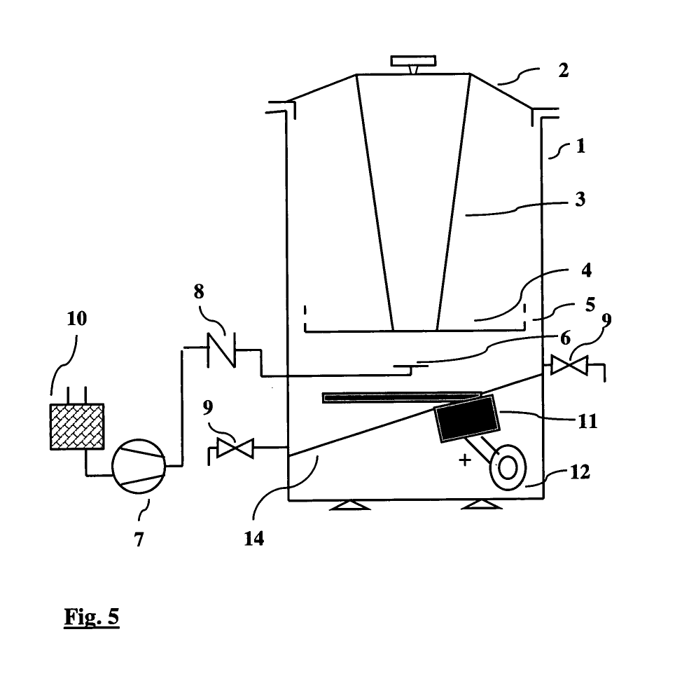

FIG. 5 is a diagrammatic representation of a further embodiment of the inventive reactor with sloping bottom and drain valve for residues.

FIG. 6 is a diagrammatic representation of a further embodiment of an inventive reactor for discontinuous operation with several plates and additional lateral heating.

FIG. 7 is a diagrammatic view of a further embodiment of an inventive double-walled reactor for continuous operation and with several plates.

FIG. 8 is a diagrammatic view of a further embodiment of an inventive reactor with several plates, lateral heating and a downstream bubble column for continuous operation.

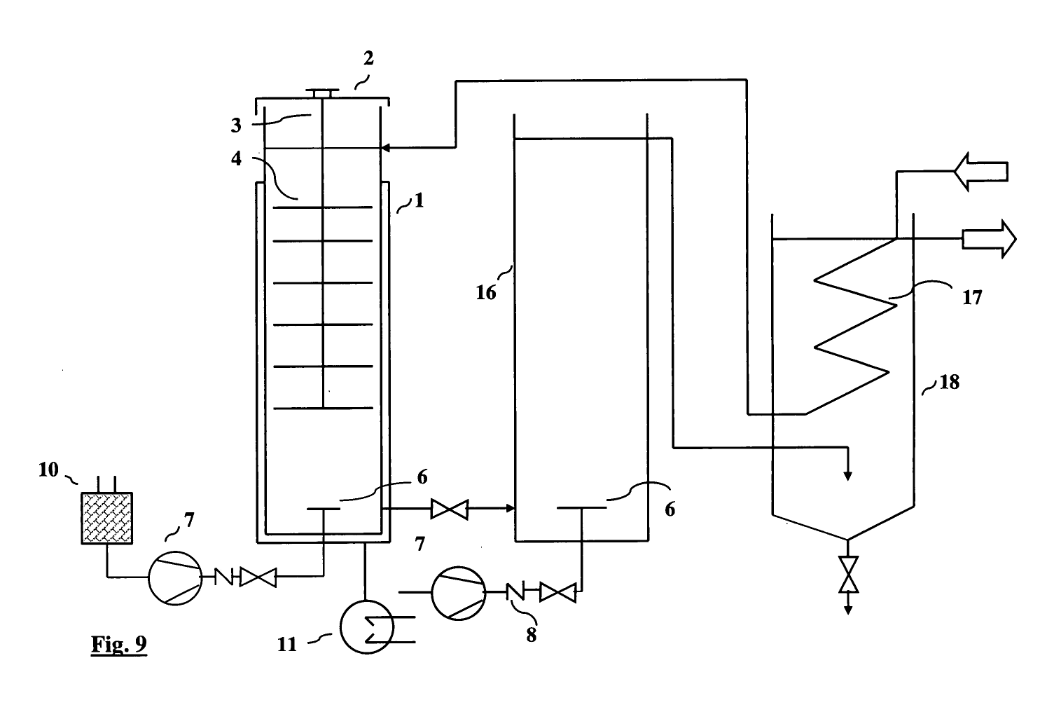

FIG. 9 is a diagrammatic view of a further embodiment of an inventive double-walled reactor and downstream bubble column, as well as the sedimentation tank for continuous operation.

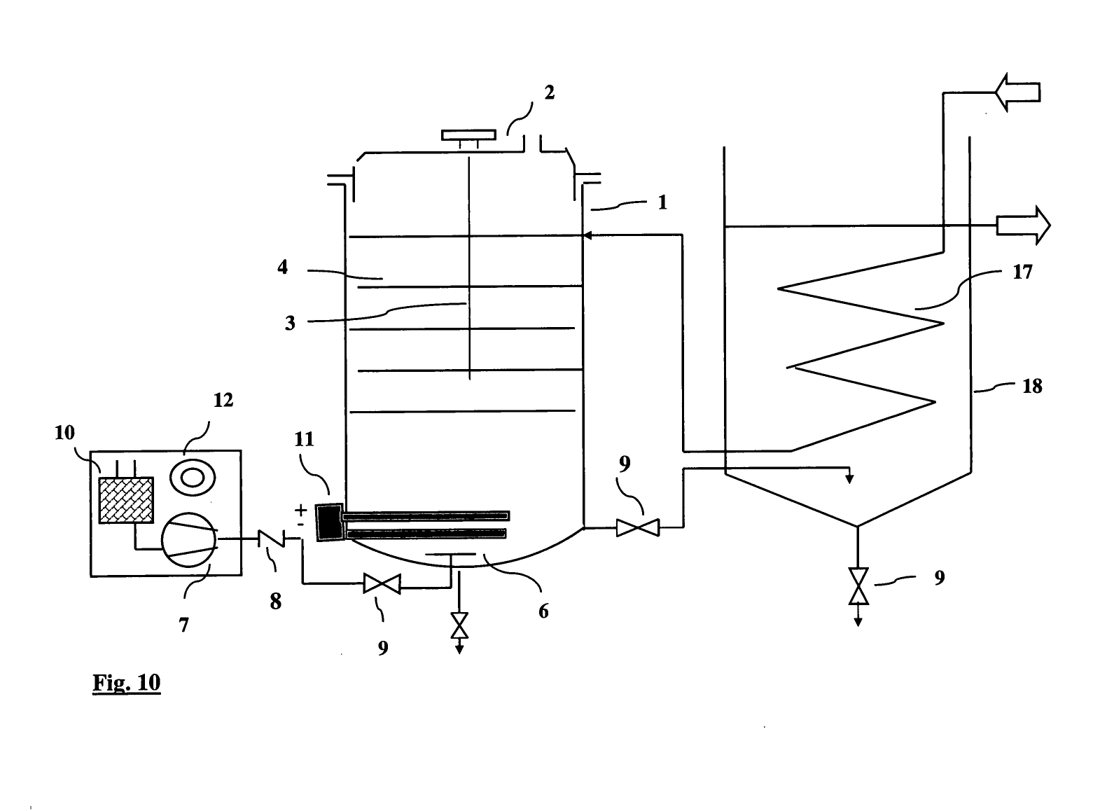

FIG. 10 is a diagrammatic view of a further, simple embodiment of an inventive reactor with direct heating and sedimentation tank for continuous operation.

FIG. 1 represents the simplest embodiment of the reactor and which comprises the following parts: treatment chamber 1, cover 2, bars 3, which connect the plate 4 with the cover, perforated border 5, air distributor 6, ventilating pump 7, which is connected to the distributor by means of a check valve 8, activated carbon filter 10 and which can be heated from below with the aid of external energy sources 11.

FIGS. 2 and 3 show two further reactors with their own heater 11 and electric controller 12 and a casing in the form of a stand, which can either indirectly or directly heat the water and by increasing the distance between the treatment chamber and the bottom can facilitate the pouring out of water through the outlet. For ventilation purposes air can be passed to the suction side via an activated carbon filter 10, so as to prevent any pollutants or contaminants in the introduced air from passing into the water.

In FIG. 4 the ventilating pump 7, activated carbon filter 10, heater 11 and controller 12 are all integrated into the casing 13 below the treatment chamber.

Whereas in water heaters use is normally made of a bimetal for regulating the current supply, in the case of the reactors according to the invention use is made of an electric controller, which randomly controls the heater power. In the case of the bimetal, after reaching a given temperature, heat is uninterruptedly supplied to the water. However, according to the invention, for effective treatment the water may need a longer uninterrupted energy supply time and this could not be controlled using a bimetal. In addition, the medium requires less energy for keeping its temperature at a specific constant level. The control can take place manually or automatically using time switching.

Whilst maintaining the aforementioned optimization, the criteria for larger reactors for discontinuous operation can be raised at random and in addition there can be lateral heating and the number of plates can be increased. To save energy the treatment chamber can be provided with insulating material so as to reduce heat losses.

In FIG. 5, at the lowest point of the treatment chamber, the reactor has an additional outlet valve 9 for sludge removal, as well as a sloping bottom 14.

A larger, discontinuously operating reactor can be equipped with several plates and a border and heating can take place laterally as well as from the bottom or a double-walled structure can be used (FIGS. 6 and 7). For a continuous operation of the inventive apparatus, the installation comprises a reactor and a bubble column, where following the treatment in a first reactor the water is further aerated (FIG. 8) and there is a sedimentation tank (FIG. 9). The interior of the reactor is equipped with several horizontal central or off set plates and can have a double-walled structure, whilst also being laterally heatable. It is unimportant whether heating takes place directly or indirectly. In the case of direct heating and as opposed to the situation in DE 197 27 357 A1, the heating bars instead of sloping are horizontal and housed in the lower region of the plates. In this reactor the water is heated to the desired temperature and is simultaneously aerated. The water then passes into a bubble column, where the water is only aerated. Finally there is a downstream sedimentation tank, which also serves as a heat exchanger.

The water passes from there to the consumer and the sediments are drawn off through the drain valve. If for any reason it is not possible to use a bubble column, the process can be performed without it, but this involves a longer residence time in the first reactor (cf. FIG. 10).

The continuously operating reactor can also be used solely for lime reduction or for setting the lime-carbonic acid equilibrium in the water required at the particular temperature, so as to avoid fouling in the installation.

Numerous pollutants and contaminants can be encountered in the water and they cannot all be removed on the basis of the indicated process without adding chemicals. To permit the removal from the water of further pollutants at elevated temperature according to the present invention it is sometimes necessary to use chemicals or other gases.

As is known, for water treatment e.g. iron and aluminium chloride (flocculating agents) are used for eliminating phosphates, humic substances, colloids and heavy metals. At ambient temperature and accompanied by intense stirring, they form microflakes in the water and absorb the pollutants in the form of hydroxo complexes and are in this form removed from the water. At normal ambient temperature such microflakes cannot or can only be sedimented with great difficulty. However, in order to produce settlable macroflakes from the microflakes, additional polymers (flocculation aids) are required. A production of liquid polymers and the addition thereof together with iron and aluminium chloride under precisely calculated stirring intensities is very complicated and difficult, so that the use thereof is only possible for large water and sewage treatment plants (e.g. in the so-called third cleaning stage or simultaneous precipitation of municipal sewage treatment plants).

According to the invention flocculating agents only dissolve fully in water at higher temperatures and readily mix in ideal form in the water. In the case of the inventive reactor there is automatically a mixing through heating the water. On cooling the water initially microflakes and after further cooling, even without flocculation aids, macroflakes are formed and settle easily. Thus, for this process not only is an intense stirring unnecessary, but also there is no need to use polymers. Therefore these chemicals can be very effectively and inexpensively used in smaller reactors without the aid of stirring equipment and the like. This process is performed even better through ventilation, so that as from approximately 30° C. large and easily sedimentable flakes are formed, which are deposited after stopping ventilation and cooling. This process is particularly suitable for the treatment of larger water and sewage quantities for hot regions, where the water can easily be brought to high temperatures using solar energy.

In order to carefully treat water on the basis of the coupled chemical-thermal process, preference in the case of discontinuous reaction performance is given to the use of a further apparatus. With the aid of a sloping settling tank and a second drain valve, apart from residues on the plate which can be disposed of externally, residues below the plate can be drawn off from below. Ventilation takes place through a valve and chemicals are manually added to the treatment chamber (cf. FIG. 6). The chemical-thermal process can be readily performed in the discontinuous plant according to the invention and a dosing pump is used for chemical dosing.

Further uses of the reactor and process according to the invention, accompanied by the use of said chemicals, are e.g. drinking, surface and waste water treatment, as well as sludge treatment in general. The advantages of this chemical process when using these chemicals are a lower chemical consumption, better filterability, less sludge production and reduction of the quantity of these chemicals required, elimination of polymers and reduced costs during sludge disposal.

Thus, if a heat treatment of the water is not sufficient for eliminating pollutants in the reactor developed according to the invention, as a function of needs these and other chemicals and gases (such as e.g. pure oxygen or ozone) can be added to the water.

It is also possible for the reactor cover to be made from glass and by fitting a UV lamp to the top of the reactor to simultaneously irradiate the reactor content in order to permit or accelerate the oxidation of further pollutants. Deposited residues can then be removed from the treatment chamber together with the fouling elements by means of the drain valve in the lower part of said chamber.

The thermal reactor according to the invention is a large capacity reactor for chemical reaction performance at higher temperatures, particularly in dilute solutions with a small proportion of reactants, which can also be used in other fields of chemical reaction performance. The treatment chamber can be heated not only electrically, but after corresponding modifications also with the aid of fossil or renewable energy sources. Thus, the inventive reactor can be used for the treatment of water in general for decentralized drinking water treatment on the premises of consumers and in particular in regions without any electric power supply and in areas suffering from catastrophes. For ventilation purposes use can inter alia be made of batteries, because air pumps have a very low power requirement.

The following features can also be of significance alone or in combination for the present invention:

for heating the water with integrated heater use can be made of fossil fuels and renewable energy with corresponding heater modifications,

for stirring, gassing, stripping and chemical oxidation a gas pump with regulatable flow rate can be used,

for gassing operations the pipe can be positioned cent rally in the reactor with a gas distributor,

for precleaning the gas an activated carbon filter can be used on the suction side,

the reactor and plates can have different shapes such as circular and cylindrical,

in the case of chemical treatment with the aid of chemicals, the bottom of the discontinuously operating reactor slopes,

a second drain valve for sludge removal is placed at the lowest point of the discontinuously operated reactor,

the plates are fixed to the reactor walls of the continuously operated plant,

ring-type heaters are used for reactor heating,

a double-walled reactor is used for water heating,

superheated steam or hot oil is used as the heating source for heating the double-walled reactor,

for setting the lime-carbonic acid equilibrium for use in domestic installations working takes place as from 20° C. and chemical precipitation as from 30° C.,

the reactor is thermally insulated using insulating materials.

### REFERENCE NUMERALS LIST

1 Treatment chamber, single or double-walled
2 Cover
3 Bar (bars) for fixing plate (plates)
4 Plate(s)
5 Perforated plate border
6 Central positioned air distributor
7 Air pump
8 Check valve
9 Inlet/outlet valve
10 Activated carbon filter
11 Heater
12 Electric controller
13 Casing as stand for treatment chamber
14 Sloping bottom
15 Flowmeter
16 Bubble column
17 Pipe coil
18 Sedimentation tank

1. Process for deliming water and simultaneously removing pollutants, as well as the disinfection and destruction of permanent forms of parasites in a reactor having a reaction chamber which includes a wall, an inlet and an outlet, the process comprising the steps of:
a) heating of the water, so that the solubility of CO₂ in the water is reduced and CO₂ desorption is initiated, which can also be increased by a pH-rise (2HCO--->CO₃+CO₃²⁻);
b) simultaneously gassing the water by means of air introduction; whereby CO₂ discharge is increased
c) providing and arranging one or several removable or fixed plates in the reaction chamber with intense mixing accompanied by the deflection of the water flow at the wall, as well as increased crystal nucleation and crystal growth on the wall and;
d) keeping the heated water at an elevated temperature if necessary and gassing or further gassing of the water takes place without a heat supply;
wherein the resulting lime and fouling elements which have been deposited below the plate or plates and on the heating surfaces or reactor walls are detached by turbulence and discharged through the water.

2. Reactor for deliming water and simultaneously removing pollutants, as well as the disinfection and destruction of permanent forms of parasites, the reactor comprising
a treatment chamber with an inlet for the water to be treated and an outlet for the treated water;
a direct or indirect heater for the water;
one or more horizontal, removable plates for deflecting the water flow in the chamber, which plates are fixed in a lower area of the reactor and spaced from the chamber's bottom and side wall,
a gassing device disposed outside the reactor and having a pipe passing centrally into the reactor and with a gas distributor terminating below the plates,
and wherein in the case of a discontinuously operated reactor the outlet is positioned between the chamber bottom and the plate or plates, and in the case of a continuously operated reactor the outlet is positioned above the plate or plates.

3. The reactor according to claim 2, wherein the reactor includes a cover and the plates are fixed to the reactor cover by one or more high-grade steel bars.

4. The reactor according to claim 3, wherein the reactor together with the plate or plates is made from stainless steel or any thermally resistant material with a high surface energy.

5. The reactor according to claim 4, wherein the plate or plates have a perforated border.

6. The reactor according to claim 5, wherein the reactor wall surface in contact with the water is rough.

7. The reactor according to claim 6, wherein a second bubble column is formed in the case of a continuous operation reactor.

8. The reactor according to claim 2, wherein the water is heated with an integrated electric heater, and the heater is positioned directly or indirectly below and/or laterally of the reactor.

9. The reactor according to claim 2, wherein the reactor is double-walled and the water is heated by means of heat exchange with steam or hot oil.
